(19) United States
(12) Patent Application Publication
(10) Pub. No.: US 2015/0192498 A1
(43) Pub. Date: Jul. 9, 2015

(54) Engine Misfiring Diagnosis Device

(71) Applicant: Fuji Jukogyo Kabushiki Kaisha, Tokyo (JP)

(72) Inventor: Daisuke TAKAHASHI, Tokyo (JP)

(21) Appl. No.: 14/581,914

(22) Filed: Dec. 23, 2014

(30) Foreign Application Priority Data
Jan. 8, 2014 (JP) 2014-001861

(51) Int. Cl. G01M 15/11

(52) U.S. Cl. CPC G01M 15/11

(57) ABSTRACT

An engine misfiring diagnosis device includes: a misfiring diagnosis value calculator that calculates a misfiring diagnosis value for determination of misfiring, based on an amount of rotational fluctuations among cylinders; a reference determination threshold calculator that calculates a reference determination threshold for determining occurrence of misfiring, based on an engine operating state; a first misfiring determiner that compares the misfiring diagnosis value with the reference determination threshold, and determines misfiring of a cylinder being diagnosed; and a second misfiring determiner that, if the first misfiring determiner has determined misfiring is occurring, performs re-determination regarding misfiring for the cylinder being diagnosed, based on a difference between a value obtained by correcting the misfiring diagnosis value of the cylinder being diagnosed with a rotational fluctuation correction value based on the engine operating state, and the misfiring diagnosis values of the cylinders before and after the cylinder being diagnosed in combustion process order.

### CROSS-REFERENCE TO RELATED APPLICATIONS

The present application claims priority from Japanese Patent Application No. 2014-001861 filed on Jan. 8, 2014, the entire contents of which are hereby incorporated by reference.

### BACKGROUND

1. Technical Field

The present invention relates to an engine misfiring diagnosis device which prevents misdiagnosis when diagnosing whether or not there is misfiring of an engine.

2. Related Art

Some engine misfiring diagnosis devices employ a technology where engine rotational fluctuation is calculated at each predetermined crank angle to diagnosis engine misfiring. Misfiring can be diagnosed by calculating the amount of fluctuation in revolutions due to misfiring as engine rotational fluctuation for each predetermined crank angle, and comparing this engine rotational fluctuation with a predetermined determination level, since there is a strong correlation between cylinder pressure (combustion pressure) in the combustion process, and engine rotations in the combustion process.

For example, Japanese Unexamined Patent Application Publication (JP-A) No. 5-34243 discloses a technology where deviation in time elapsed between cylinders of which the explosion processes are adjacent, or deviation in time elapsed between cylinders of which the explosion processes are at certain intervals, and a deviation equivalent to this amount of rotational fluctuation is compared with a set value serving as a determining level, thereby determining misfiring.

However, there are cases where distinctive rotational fluctuation may occur in engines due to factors other than misfiring. Examples of such factors include fluctuation in running state and engine load due to a sudden change in road state, such as when driving on a rough road, and instable combustion due to inferior fuel being used. In such cases, the technology disclosed in JP-A No. 5-34243 may result in misdiagnosing rotational fluctuations due to factors other than misfiring as being due to misfiring, since the amount of rotational fluctuation is rigidly compared with the determination level.

### SUMMARY OF THE INVENTION

The present invention has been made in light of the above-described problem, and accordingly it is an object thereof to provide an engine misfiring diagnosis device capable of eliminating the effects of engine rotational fluctuations due to factors other than misfiring, and prevent misdiagnosis when diagnosing misfiring.

An aspect of the present invention provides an engine misfiring diagnosis device which diagnoses whether or not an engine is misfiring. The engine misfiring diagnosis device includes a misfiring diagnosis value calculator that calculates a misfiring diagnosis value for determination of misfiring, based on amount of rotational fluctuations among cylinders; a reference determination threshold calculator that calculates a reference determination threshold for determining occurrence of misfiring, based on an engine operating state; a first misfiring determiner that compares the misfiring diagnosis value with the reference determination threshold, and determines misfiring of a cylinder being diagnosed; and a second misfiring determiner that, in the case where the first misfiring determiner has determined misfiring is occurring, performs re-determination regarding misfiring for the cylinder being diagnosed, based on a difference between a value obtained by correcting the misfiring diagnosis value of the cylinder being diagnosed with a rotational fluctuation correction value based on the engine operating state, and the misfiring diagnosis values of the cylinders before and after the cylinder being diagnosed in combustion process order.

### BRIEF DESCRIPTION OF THE DRAWINGS

FIG. 1 is a schematic configuration diagram of an engine system;

FIG. 2 is a block diagram regarding a misfiring diagnosis function;

FIG. 3 is an explanatory diagram of misfiring diagnosis values;

FIG. 4 is an explanatory diagram illustrating a change in misfiring diagnosis values when firing;

FIG. 5 is an explanatory diagram illustrating a change in misfiring diagnosis value due to factors other than misfiring;

FIG. 6 is an explanatory diagram illustrating misfiring determination by rotational fluctuation compensation values; and

FIG. 7 is a flowchart illustrating a misfiring diagnosis routine.

### DETAILED DESCRIPTION

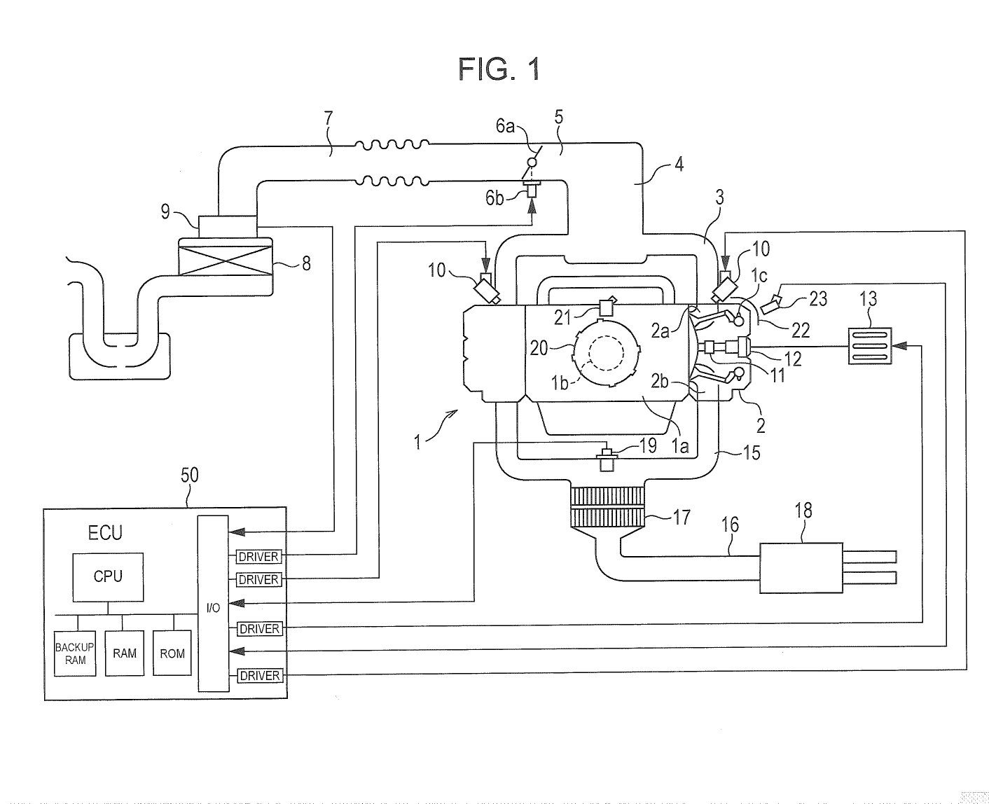

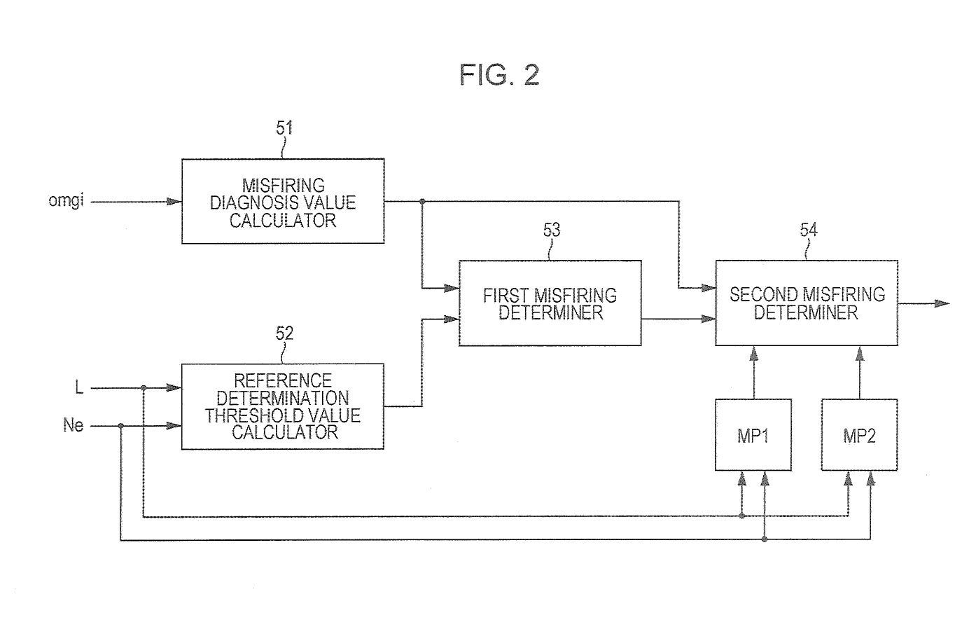

An implementation of the present invention will be described with reference to the drawings. In FIG. 1, reference numeral 1 denotes an engine. The engine 1 is a horizontal-opposed four-cylinder engine, and a cylinder block 1a forms left and right banks with a crankshaft. Each bank has a cylinder head 2 that has an intake port 2a and a discharge port 2b. An injector 10 is attached immediately upstream of each intake port 2a. The cylinder head 2 is provided with a spark plug 11. The spark plug 11 has a discharger that is exposed within a combustion chamber. An ignition coil 12 is connected to the spark plug 11, and an igniter 13 is connected to the ignition coil 12.

An intake manifold 3 communicates with the intake port 2a of each cylinder, and a throttle chamber 5 communicates with the intake manifold 3 via an air chamber 4. A throttle valve 6a, which is driven to open/close by a throttle actuator 6b, is installed in the throttle chamber 5. An air cleaner 8 is attached upstream of the throttle valve 6a via an intake tube 7, and an intake airflow sensor 9 is installed immediately downstream of the air cleaner 8.

An exhaust manifold 15 communicates with the discharge port 2b of each cylinder. The exhaust manifolds 15 are joined downstream into a collector which communicates with an exhaust pipe 16. A catalytic converter 17 for purging exhaust fumes is installed along the exhaust pipe 16, and a muffler 18 is connected on the downstream side of the catalytic converter 17. An air-fuel ratio sensor 19 is installed on the upstream side of the catalytic converter 17.

A crank rotor 20 is axially mounted to the crankshaft b borne by the cylinder block 1a, and a crank angle sensor 21 that detects the crank position is disposed at the perimeter of the crank rotor 20, so as to face the crank rotor 20. Further, a cam rotor 22 is connected with a camshaft 1c of the cylinder head 2, and a cam angle sensor 23 that distinguishes the cylinders is disposed at the perimeter of the cam rotor 22, facing the cam rotor 22.

Multiple protrusions are formed on the perimeter of the crank rotor 20, serving as detection portions to be detected by the crank angle sensor 21. These protrusions are provided corresponding to specific crank angles at the before top dead center (BTDC) position of each cylinder, for example, and are detected by the crank angle sensor 21 and detection results are output as crank angle signals. An engine speed is calculated, and also control timings such as firing timing control and fuel injection control, are determined, based on the crank angle signals.

In the same way, multiple protrusions are formed on the perimeter of the cam rotor 22, serving as detection portions to be detected by the cam angle sensor 23. These protrusions are provided corresponding to specific positions at the after top dead center (ATDC) position of each cylinder, for example, and are detected by the cam angle sensor 23 and detection results are output as cam angle signals. The cam angle signals are output at a timing offset from the crank angle signals, and the output pattern of crank angle signals and cam angle signals makes it possible to distinguish a cylinder currently in the combustion process, a cylinder to be fired, and a cylinder to receive fuel injection, and so forth.

The engine 1 is controlled by an engine control unit (ECU) 50. The ECU 50 is an electronic control unit and mainly includes a microcomputer that has a central processing unit (CPU), read-only memory (ROM), random access memory (RAM), backup RAM, an I/O interface, drivers, and so forth. The ECU 50 is connected to an in-vehicle network such as a controller area network (CAN), and exchanges various types of control information through communications with other control units (not illustrated) that control an automatic transmission, brakes, suspension, and other components.

In accordance with a control program stored in memory, the ECU 50 performs engine control, such as air-fuel ratio control via the throttle actuator 6b and injector 10, ignition timing control of the spark plugs 11 via the igniter 13 which supplies power to the ignition coil 12, and so forth. The engine control is performed based on the various types of information obtained via the in-vehicle network as signals from the above-described intake airflow sensor 9, air-fuel ratio sensor 19, crank angle sensor 21, cam angle sensor 23, and various types of sensors omitted from illustration.

The ECU 50 performs misfiring diagnosis processing to determine whether or not misfiring is occurring at each cylinder, in addition to the aforementioned engine control. This misfiring diagnosis is basically performed such that whether or not there is misfiring is determined by comparing an amount of engine rotational fluctuations with a predetermined determination threshold. However, engine rotational fluctuations can occur due to external disturbance and other factors besides actual misfiring, so misdiagnosis may happen. For example, driving on a rough road where the road conditions change, such as an unpaved road, turning the air conditioner on/off, increasing power generation by the alternator, shifting down gears, other such fluctuation of load on the engine, and instable combustion due to inferior fuel being used may cause the engine rotational fluctuations to exceed the determination threshold. In such cases, misfiring may be erroneously diagnosed even through misfiring actually is not happening.

Accordingly, the ECU 50 is provided with a misfiring diagnosis value calculator 51, a reference determination threshold calculator 52, a first misfiring determiner 53, and a second misfiring determiner 54 as a misfiring diagnosis function to avoid misdiagnosis and accurately determine misfiring. In the misfiring diagnosis performed at these functional modules, the first misfiring determiner 53 compares a misfiring diagnosis value calculated at the misfiring diagnosis value calculator 51 with a reference determination threshold calculated at the reference determination threshold calculator 52, and makes a tentative determination regarding misfiring. Further, re-determination is performed at the second misfiring determiner 54 regarding whether misfiring is actually occurring, whereby misdiagnosis due to factors other than misfiring can be avoided.

Specifically, the misfiring diagnosis value calculator 51 calculates the amount of engine rotational fluctuations for each cylinder, and acquires a diagnosis value for determination of whether or not there is misfiring. This diagnosis value can basically be calculated based on the difference in engine rotation speed (engine speed) for each predetermined crank angle between two cylinders, i.e., rotational speed difference. In the present implementation, the difference in engine rotation speed corresponding to a cylinder #n and engine rotation speed corresponding to a cylinder #(n−1) one combustion process in the past is taken as the rotational speed difference, and a misfiring diagnosis value is calculated based on the rotational speed difference between these two cylinders of which the combustion processes are temporally serial.

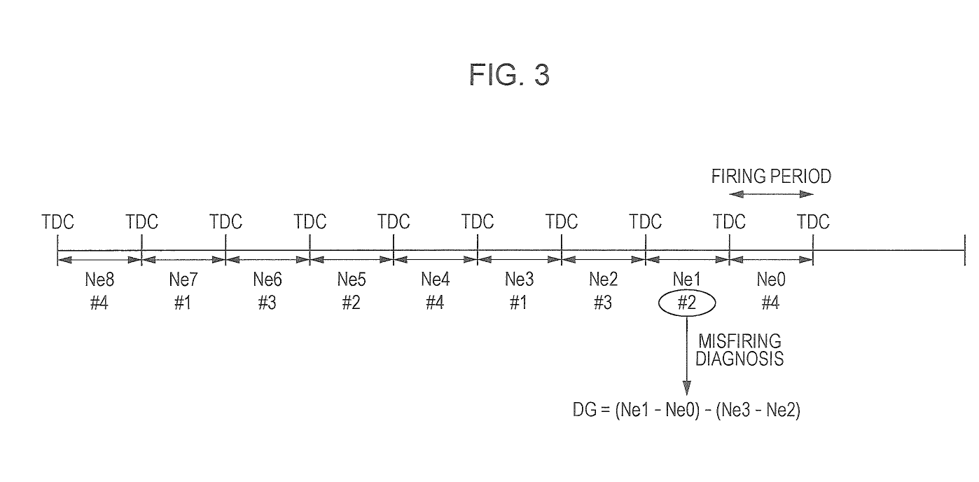

The rotational speed difference may be used as it is for the misfiring diagnosis value. Alternatively, in the present implementation, a value obtained by further differentiation from the rotational speed difference between the two cylinders of which the combustion processes are temporally serial is used as the misfiring diagnosis value. Specifically, if the combustion process order of the engine 1 having the four cylinders #1 through #4 is #1→#3→#2→#4, engine speed Ne0 corresponding to the cylinder #4 which is the current combustion process cylinder, engine speed Ne1 corresponding to the cylinder #4 which was the combustion process cylinder one before, and engine speed Ne2 corresponding to the cylinder #3 which was the combustion process cylinder two before, and obtained in time sequence as Ne3, Ne4, and so on through Ne8, as illustrated in FIG. 3. A misfiring diagnosis value DG is then calculated from the engine speeds Nei (i=0, 1, 2, . . . ) for each cylinder.

A cylinder regarding which misfiring diagnosis is to be performed is the combustion process cylinder #(n−1) one before the current combustion process cylinder #n. In the example illustrated in FIG. 3, assuming the current combustion process cylinder to be the cylinder #4, the misfiring diagnosis value DG is calculated as the difference between the rotational speed difference as to the cylinder #2 which was the combustion process cylinder one before, and the rotational speed difference as to the cylinder #1 which was the combustion process cylinder three before. As illustrated in Expression (1) below, a value obtained by subtracting the difference between the revolutions difference of the cylinder #1 which was the combustion process cylinder three before and the cylinder #3 which was the combustion process cylinder two before (Ne3−Ne2), from the revolutions difference of the cylinder #2 which was the combustion process cylinder one before and the cylinder #4 which is the current combustion process cylinder (Ne1−Ne0), is calculated as the misfiring diagnosis value for the cylinder #2.

DG=(Ne1−Ne0)−(Ne3−Ne2) (1)

The reference determination threshold calculator 52 calculates a reference determination threshold BSL to serve as a slice level for determining whether or not there is misfiring. This reference determination threshold BSL is calculated referencing a base map created beforehand based on engine load L and engine speed Ne, with interpolation calculations. A basic fuel injection amount, intake airflow, throttle position, and so forth, can be used as the engine load L.

The first misfiring determiner 53 compares the misfiring diagnosis value DG and the reference determination threshold BSL. In the case where the misfiring diagnosis value DG is equal to or smaller than the reference determination threshold BSL, determination is made that there is no misfiring occurring, and in the case where misfiring diagnosis value DG exceeds the reference determination threshold BSL, determination is made that there is the possibility of misfiring. In the case where determination is made that there is the possibility of misfiring, final misfiring diagnosis is further performed by the second misfiring determiner 54 to eliminate misdiagnosis due to the influence of factors other than misfiring.

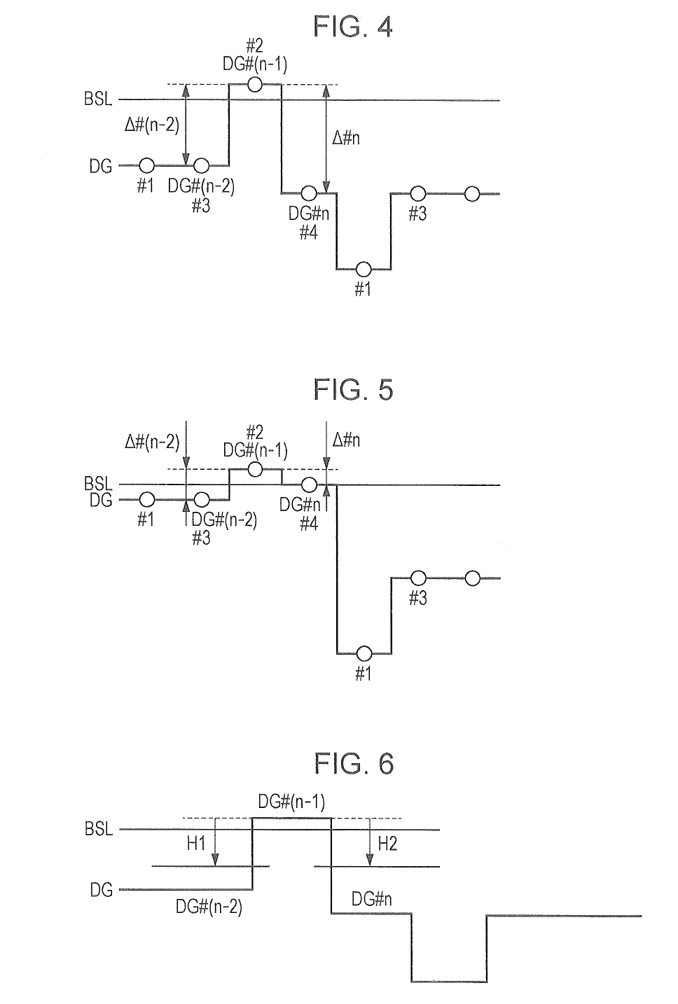

In the case where determination has been made that the first misfiring determiner 53 that there is a possibility of misfiring, the second misfiring determiner 54 re-determines whether the misfiring determination made at the first misfiring determiner 53 is caused due to the influence of factors other than misfiring or due to actual misfiring. That is to say, in the case where misfiring actually is occurring combustion is not occurring so torque is not generated at the engine, and engine rotations drop. Accordingly, as illustrated in FIG. 4, the misfiring diagnosis value DG#(n−1) of the cylinder being diagnosed (cylinder #2) exhibits a waveform which exceeds that of the misfiring diagnosis values DG#(n−2) and DG#n of the cylinders before and after (cylinders #3 and #4), and exceeds the reference determination threshold BSL. Great differences as to the cylinders before and after, A#(n−2) and Δ#n, occur as indicated by the arrows in FIG. 4.

On the other hand, in the case where engine rotational fluctuations are occurring due to factors other than misfiring, such as a rough road or poor combustion, the rotational fluctuations will occur at the cylinders before and after, not just the cylinder being diagnosed. Accordingly, while the misfiring diagnosis value DG#(n−1) of the cylinder being diagnosed exceeds the reference determination threshold BSL, the misfiring diagnosis values DG#(n−2) and DG#n of the cylinders before and after also are great, so differences as to the cylinders before and after, Δ#(n−2) and A#n, are smaller, as indicated by the arrows in FIG. 5.

Accordingly, in the case that the misfiring diagnosis value DG#(n−1) of the cylinder being diagnosed exceeds the reference determination threshold BSL, the second misfiring determiner 54 checks the difference between a value obtained by correcting the misfiring diagnosis value DG#(n−1) of the cylinder being diagnosed taking into consideration rotational fluctuations due to factors other than misfiring, and the misfiring diagnosis values DG#(n−2) and DG#n of the cylinders before and after the cylinder being diagnosed in combustion process order, thereby avoiding misdiagnosis.

Specifically, determination is made that misfiring is occurring in the case that the conditions of Expressions (3) and (4) are satisfied in addition to the conditions of Expression (2). Expression (2) is conditions of the misfiring diagnosis value DG#(n−1) of cylinder #(n−1) at the first misfiring determiner 53. Expression (3) is conditions relating to the difference between a value obtained through correction by subtracting a rotational fluctuation correction value H1 from the misfiring diagnosis value DG#(n−1) of cylinder #(n−1) and the misfiring diagnosis value DG#(n−2) of cylinder #(n−2). Expression (4) is conditions relating to the difference between a value obtained through correction by subtracting a rotational fluctuation correction value H2 from the misfiring diagnosis value DG#(n−1) of cylinder #(n−1) and the misfiring diagnosis value DG#n of cylinder #n.

DG#(n−1)>BSL (2)

DG#(n−1)−H1≧DG#(n−2) (3)

DG#(n−1)−H2≧DG#n (4)

The rotational fluctuation correction values H1 and H2 are values individually obtained from two correction maps MP1 and MP2, based on the engine operating state from the engine load L and engine speed Ne. These maps are created beforehand by obtaining engine rotational fluctuations due to factors other than misfiring, either by simulation or by experimentation or the like, for each operating region.

Accordingly, in the case where the misfiring diagnosis value DG#(n−1) of the cylinder #(n−1) exceeds the reference determination threshold BSL, as illustrated in FIG. 6, determination can be made that rotational fluctuation is not occurring at the cylinders before and after, and that the cylinder being diagnosed is misfiring, in the case where a value obtained by subtracting the rotational fluctuation correction value H1 from the misfiring diagnosis value DG#(n−1) is equal to or greater than the misfiring diagnosis value DG#(n−2) of cylinder #(n−2), and a value obtained by subtracting the rotational fluctuation correction value H2 from the misfiring diagnosis value DG#(n−1) is equal to or greater than the misfiring diagnosis value DG#n of cylinder #n.

On the other hand, even in the case where the misfiring diagnosis value DG#(n−1) of the cylinder #(n−1) exceeds the reference determination threshold BSL, if either of DG#(n−1)−H1<DG#(n−2) and DG#(n−1)−H2<DG#n hold, determination can be made that that rotational fluctuation is occurring at the cylinders before and after, and that the cylinder being diagnosed is not misfiring, thereby avoiding misdiagnosis.

Note that the present implementation is described as taking the difference between rotational speed differences of the two cylinders of which the combustion process order is temporally serial as the diagnosis value of misfiring diagnosis, an arrangement may be made where the sign of the rotational speed differences (reference for subtraction) is included, and the diagnosis value is obtained based on engine rotational fluctuations between cylinders with a predetermined interval between the combustion processes.

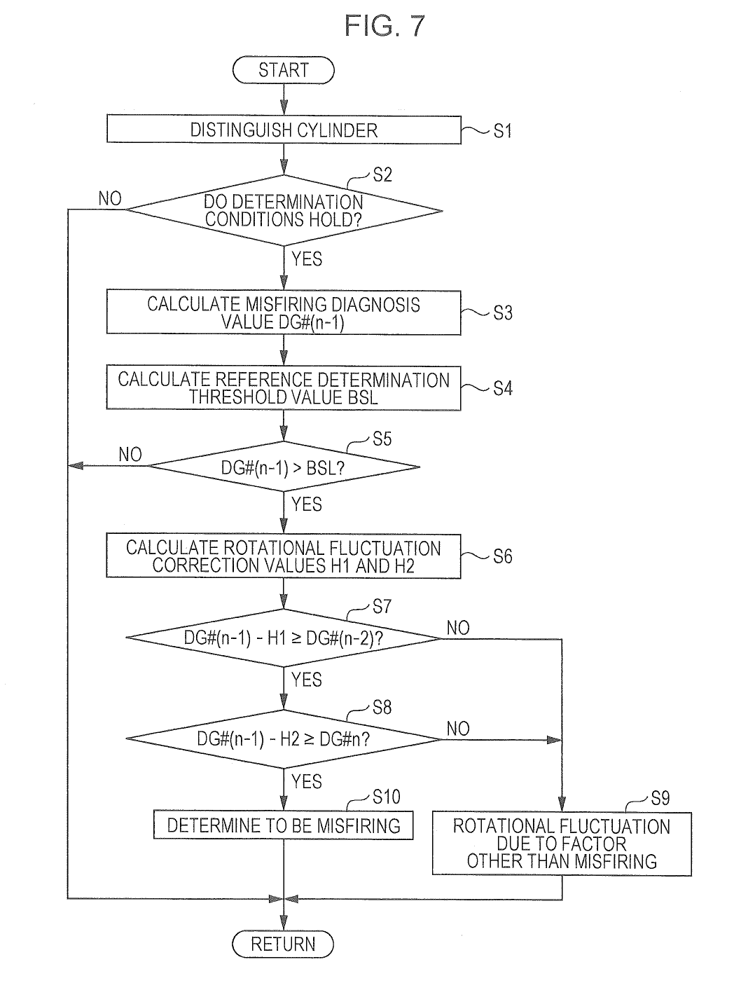

The above-described misfiring diagnosis is carried out as a program process at the ECU 50. Next, the misfiring diagnosis program process of the ECU 50 will be described with reference to the flowchart in FIG. 7.

The flowchart in FIG. 7 illustrates a misfiring diagnosis routine executed each firing cycle. First, in step S1, which of cylinders #1 through #4 is the current combustion process cylinder is distinguished based on signals output from each of the crank angle sensor 21 and the cam angle sensor 23. Distinguishing of the cylinder is performed by, for example, identifying which cylinder will be at top dead center next, from the order of combustion processes, and input intervals and input pattern of the crank angle signals and cam angle signals (number of signal pulses). The current combustion process cylinder and firing cylinder are thus distinguished.

Next, the flow advances to step S2, and whether or not misfiring diagnosis conditions hold is checked. The diagnosis conditions here are conditions of an operating range in which the combustion state can be deemed to be stable, the engine load L and engine speed Ne being a predetermined value or higher, and fuel cut not being performed, for example. In the case where the diagnosis conditions do not hold in step S2, the flow exits. In the case where the diagnosis conditions hold, the flow advances to step S3.

In step S3, the combustion process cylinder #(n−1) one before the current combustion process cylinder #n regarding which the cylinder has been distinguished, is taken as the object of diagnosis. The misfiring diagnosis value DG#(n−1) of the cylinder #(n−1) is calculated from the engine speeds Nei (i=0, 1, 2, . . . ) for each cylinder stored in the work memory of the ECU 50 in time series. This misfiring diagnosis value DG#(n−1) is a value obtained by further differentiation from the rotational speed difference between the two cylinders of which the combustion processes are temporally serial, as illustrated in Expression (1) above.

In the following step S4, the reference determination threshold BSL is calculated referencing a map in which the engine load L and engine speed Ne are parameters.

In step S5, the misfiring diagnosis value DG#(n−1) is compared with the reference determination threshold BSL. In the case where DG#(n−1)≦BSL, determination is made that no misfiring is occurring and the state is normal, so the flow exits the routine. In the case where DG#(n−1)>BSL, tentative determination is made that misfiring is occurring, and the flow advances to step S6.

In step S6, two correction maps MP1 and MP2 are referenced in which the engine load L and engine speed Ne are parameters, and rotational fluctuation correction values H1 and H2 are calculated to determining the relation of cylinders regarding which the order of combustion processes is temporally serial.

From step S7 and thereafter, re-determination is made regarding whether or not misfiring is actually occurring. In this re-determination, in step S7 a value obtained by subtracting the rotational fluctuation correction value H1 from the misfiring diagnosis value DG#(n−1) of cylinder #(n−1) and the misfiring diagnosis value DG#(n−2) of cylinder #(n−2) are compared, and in step S8 a value obtained by subtracting the rotational fluctuation correction value H2 from the misfiring diagnosis value DG#(n−1) of cylinder #(n−1) and the misfiring diagnosis value DG#n of cylinder #n are compared.

In the case where DG#(n−1)−H1<DG#(n−2) in step S7, or in the case where DG#(n−1)−H2<DG#n in step S8, the flow advances to step S9, where determination is made that the misfiring diagnosis in step S5 was not an actual misfiring by was effects of rotational fluctuations due to factors other than misfiring. On the other hand, in the case where DG#(n−1)−H1≧DG#(n−2) in step S7 and also DG#(n−1)−H2≧DG#n in step S8, determination is made in step S10 that misfiring is actually occurring.

In the case of determining that misfiring is occurring, the number of times of misfiring is counted for each cylinder for example, and when the number of times of misfiring reaches a predetermined value, or alternatively when the misfiring rate per certain revolutions is calculated for the four cylinders and this misfiring rate is consecutively smaller than a set value by a set number of times, determination is made that an abnormal state has occurred. When determination is made that an abnormal state has occurred, the diagnosis results are recorded, and also the driver is warned by lighting a lamp or displaying the misfiring cylinder or the like.

Thus, according to the present implementation, in the case where misfiring has been determined by conventional misfiring determination, i.e., misfiring has been determined by determination of whether or not the misfiring diagnosis value of the cylinder being diagnosed exceeds the reference determination threshold, the difference is checked between a value obtained by correcting the misfiring diagnosis value of the cylinder being diagnosed, taking into consideration rotational fluctuations due to factors other than misfiring, and the misfiring diagnosis values of the cylinders before and after the cylinder being diagnosed in combustion process order, so as to re-determine whether misfiring is actually occurring, or whether this is caused due to effects from factors other than misfiring. Accordingly, the influence of distinctive rotational fluctuation of the engine due to factors other than misfiring can be eliminated and misdiagnosis can be avoided, thereby improving the reliability of diagnosis.

1. An engine misfiring diagnosis device which diagnoses whether or not an engine is misfiring, comprising:
a misfiring diagnosis value calculator that calculates a misfiring diagnosis value for determination of misfiring, based on an amount of rotational fluctuations among cylinders;
a reference determination threshold calculator that calculates a reference determination threshold for determining occurrence of misfiring, based on an engine operating state;
a first misfiring determiner that compares the misfiring diagnosis value with the reference determination threshold, and determines misfiring of a cylinder being diagnosed; and
a second misfiring determiner that, in the case where the first misfiring determiner has determined misfiring is occurring, performs re-determination regarding misfiring for the cylinder being diagnosed, based on a difference between a value obtained by correcting the misfiring diagnosis value of the cylinder being diagnosed with a rotational fluctuation correction value based on the engine operating state, and the misfiring diagnosis values of the cylinders before and after the cylinder being diagnosed in combustion process order.

2. The engine misfiring diagnosis device according to claim 1, wherein the misfiring diagnosis value is calculated as a value obtained by further differentiation from the rotational speed difference between two cylinders of which the combustion processes are temporally serial.

3. The engine misfiring diagnosis device according to claim 1, wherein different correction value are used as the rotational fluctuation correction value for a cylinder of which the combustion process order is before the cylinder being diagnosed and a cylinder of which the combustion process order is after the cylinder being diagnosed.

4. The engine misfiring diagnosis device according to claim 2, wherein different correction value are used as the rotational fluctuation correction value for a cylinder of which the combustion process order is before the cylinder being diagnosed and a cylinder of which the combustion process order is after the cylinder being diagnosed.
